(19) United States
(12) Patent Application Publication
(10) Pub. No.: US 2006/0078007 A1
(43) Pub. Date: Apr. 13, 2006

(54) Uniform distribution of SS7 traffic over multiple connections

(75) Inventors: Manfred Angermayr, Schrobenhausen (DE); Jurgen Wodarz, Wolfratshausen (DE)

Correspondence Address: SIEMENS CORPORATION;INTELLECTUAL PROPERTY DEPARTMENT, 170 WOOD AVENUE, SOUTH, ISELIN, NJ, 08830, US

(73) Assignee: SIEMENS AKTIENGESELLSCHAFT

(21) Appl. No.: 11/244,781

(22) Filed: Oct. 6, 2005

(30) Foreign Application Priority Data
Oct. 11, 2004 (DE) 10 2004 049 465.7

(51) Int. Cl. H04J 3/12

(52) U.S. Cl. 370/522

(57) ABSTRACT

The present invention relates to a method and a network element for distributing SS7 traffic to a destination in an SS7 network over a plurality of links, wherein the distribution is handled on the basis of link selection parameters that are derived from message fields of the SS7 traffic, and wherein a link is uniquely assigned to each link selection parameter value. The method is characterized in that during the operation of the SS7 network one traffic volume per link selection parameter value is monitored, and the link selection parameter values are reassigned to the links on a time- or event-driven basis subject to the proviso that the ratio of transported traffic volume to connection capacity is as far as possible the same for all links, with a transfer procedure similar or identical to the change back procedure being used for links with reassigned link selection parameter values in order to avoid messages overtaking one another.

The present invention relates to a method and a network element which enables SS7 traffic to be evenly distributed over a plurality of links in conventional and IP-based SS7 networks even in cases where some of the values used for link selection (e.g. SLS values) occur more often than others.

Modern communication networks typically transport two types of traffic or data. The first type is the traffic which is sent or received by users or subscribers and whose transmission is often billed to the user or subscriber. This type of traffic is also referred to as user traffic, user data or subscriber traffic. The second type of traffic is that which is caused by the network management and is often referred to as management traffic.

In the field of telecommunication the management traffic is also referred to as signaling traffic. In this context the term “signaling” refers to the exchange of signaling messages between different network elements such as database servers, local exchanges, transit exchanges and user terminals. A widely known protocol for transmitting signaling information of this type is Signaling System 7 (SS7), often also referred to as the Common Channel Signaling System 7 (CCS7).

Signaling System 7 has been standardized by the International Telecommunication Union (ITU) in the standard series Q.7xx and fulfills all the signaling requirements of present-day telecommunication networks.

In this case Signaling System 7 forms an independent network in which SS7 messages are exchanged between the network elements via bi-directional channels which are referred to as links. The signaling takes place outside the (voice) band (out-of-band) and not inside the band (in-band) on channels which are reserved for the user data (e.g. voice). As well as faster connection setup times this enables a number of functions, for example intelligent network (IN) services, which can execute in the signaling network without the need to set up parallel user data connections.

The elements of an SS7 network are known as signaling points, which are uniquely identified by a signaling point code (SPC). Said point codes are transmitted in the signaling messages between signaling points and in each case designate the source and the destination of a message. Each signaling point uses a routing table to select a suitable signaling path for each message.

Signaling System 7 uses a protocol stack in which the hardware and software functions of the SS7 protocol are subdivided into functional abstractions referred to as levels. Subject to certain restrictions, said levels can be mapped onto the Open Systems Interconnect (OSI) 7-layer model or the layer model of the International Standards Organization (ISO).

The bottom three levels are termed the Message Transfer Part (MTP). MTP Level 1 defines the physical, electrical and functional characteristics of the digital signaling link. MTP Level 2 ensures the correct end-to-end transmission of a message via a signaling link. MTP Level 3 provides the routing of messages between signaling points of the SS7 network.

Functions are provided in SS7 by what are referred to as “user parts”. A commonly used user part is the ISDN User Part (ISUP) which defines the protocol that is used for reserving, administering and releasing lines which transport the user traffic between exchanges (e.g. between the calling and the called party). In certain countries the less powerful Telephone User Part (TUP) is used instead of the ISUP.

In conventional telecommunication networks all user parts use MTP Level 3 for message transport, whereby MTP Level 3 for its part relies on Levels 2 and 1 to provide the transport and to perform the link management.

Current developments are directed toward replacing the signaling that is based on exclusive and therefore expensive lines by services that are based on the Internet Protocol (IP). However, if IP is introduced in place of MTP Level 1, this also requires a replacement of the formerly used MTP Level 2. For this reason the Internet Engineering Task Force (IETF) specified the MTP3 User Adaptation Layer (M3UA) protocol in RFC 3332, which protocol runs on top of the Stream Control Transmission Protocol (SCTP) and replaces MTP Level 2 and 3. Alternative protocol stacks based on the Internet Protocol provide for the transmission of the MTP Level 3 information by means of the IETF Sigtran protocols M2PA or M2UA via SCTP and IP.

The aim of the combinations M3UA/SCTP/IP, MTP3/M2PA/SCTP/IP or MTP3/M2UA/SCTP/IP is to create a means whereby it is possible—analogously to the MTP Level 3 of conventional SS7 networks—to transport messages of the user parts between SS7 signaling gateways (SG), media gateway controllers (MGC) or IP-based databases.

If a plurality of links exist for transporting a message to a destination on the MTP3 or, as the case may be, M3UA protocol level, a subdivision of the traffic between said links is provided. For this purpose the field known as the “Signaling Link Selection” (SLS) field is evaluated, which field is a component of each MTP3 message and has a value set of 16 different values.

So that the load balancing method specified in the underlying ITU standard series Q.7xx operates satisfactorily with the aid of this SLS field, it must be ensured that all 16 values occur with the same frequency. However, in real telecommunication networks this is almost never the case, since asymmetric traffic streams, load balancing taking place over several stages and other causes regularly result in unbalanced loads, i.e. the links available to the destination are unevenly loaded, for instance because one SLS value occurs much more frequently than other SLS values.

Known methods for extending the value set for load balancing which evaluate further fields of the MTP3 routing label, for example, in addition to the SLS field achieve at best an improved distribution as a result of the extended value set, but cannot reliably solve the problem, in particular because the further fields of the MTP3 routing label often do not vary sufficiently. For example, the messages from a specific endpoint always carry the same originating point code in the routing label, so the additional bits of the extended SLS value that were formed from this field do not vary.

An object of the present invention is therefore to specify a method and a network element which enable an even distribution of SS7 traffic over a plurality of links in conventional and IP-based SS7 networks even in cases where some of the values used for link selection (e.g. SLS values) occur more often than others.

This object is achieved by a method for distributing SS7 traffic to a destination in an SS7 network over a plurality of links, wherein the distribution is implemented on the basis of link selection parameters which are derived from message fields of the SS7 traffic, and wherein a link is uniquely assigned to each link selection parameter value. The method is characterized in that
during the operation of the SS7 network one traffic volume per link selection parameter value is monitored, and
the link selection parameter values are reassigned to the links on a time- or event-driven basis subject to the proviso that the ratio of transported traffic volume to connection capacity is as far as possible the same for all links, with a transfer procedure similar or identical to the change back procedure being used for links with reassigned link selection parameter values in order to avoid messages overtaking one another.

Advantageously the link selection parameters include at least the Signaling Link Selection (SLS) parameter, but can also comprise extended link selection parameters known from the prior art, for example an SLS parameter extended by further bits from other fields of the MTP3 routing label.

If the connection capacity of all links to the destination is the same, the reassignment in the application of the invention takes place in such a way that the transported traffic volume is as far as possible the same for all links.

In order to determine the traffic volume, the messages per link selection parameter value, for example, can be counted, which is advantageous in the case of messages with essentially the same length, or the information volume, measured in bytes, transmitted per link selection parameter value can be determined, which yields good results in particular when there are great variations in message length.

The invention is equally applicable to signaling links of a conventional TDM-based SS7 network and the SCTP associations of an IP-based SS7 network.

The invention further relates to a network element having means for performing the method.

Other advantageous embodiments are set forth in the dependent claims.

An advantage of the invention is to be seen in the fact that it is ensured by means of the invention that—irrespective of fluctuating and/or extremely unequal distributions of the SLS values in the MTP message stream—an approximately equal and to that extent optimal loading of the links to the destination can be achieved, and moreover without human intervention by an operator.

Exemplary embodiments of the present invention will be explained in more detail below.

First, the method known from ITU-T Q.7xx will be described.

In Q.7xx only the SLS values are provided as link selection values, but the following explanations also apply analogously to arbitrarily extended SLS values. Provided all links are active, the following assignment table 1 for the assignment of link selection parameter values (in this case: SLS values) to connections (in this case: links) apply to a first network element (e.g. a node or endpoint) of an SS7 network which is connected to a specific destination (likewise a node or endpoint) of the SS7 network by means of a total of four links 1 . . . 4:

TABLE 1

| SLS value | Link |
|---|---|
| 0 | 1 |
| 1 | 1 |
| 2 | 1 |
| 3 | 1 |
| 4 | 2 |
| 5 | 2 |
| 6 | 2 |
| 7 | 2 |
| 8 | 3 |
| 9 | 3 |
| 10 | 3 |
| 11 | 3 |
| 12 | 4 |
| 13 | 4 |
| 14 | 4 |
| 15 | 4 |

This means that MTP messages whose SLS field has one of the values 0 . . . 3 are sent via the link 1; MTP messages whose SLS field has one of the values 4 . . . 7 are sent via link 2, and so on.

An equal load distribution in which 25% of the traffic is transported by each link can be achieved only under the precondition—which never happens in practice—that all the values 0 . . . 15 of the SLS field occur with the same frequency.

In practice, on the other hand, unbalanced loads are often to be encountered which—as explained at the beginning—can have different causes. Table 2 shows an example of such an unbalanced load:

TABLE 2

| SLS value | H | Link |
|---|---|---|
| 0 | 0% | 1 |
| 1 | 0% | 1 |
| 2 | 0% | 1 |
| 3 | 0% | 1 |
| 4 | 20% | 2 |
| 5 | 10% | 2 |
| 6 | 10% | 2 |
| 7 | 10% | 2 |
| 8 | 10% | 3 |
| 9 | 10% | 3 |
| 10 | 10% | 3 |
| 11 | 5% | 3 |
| 12 | 5% | 4 |
| 13 | 5% | 4 |
| 14 | 5% | 4 |
| 15 | 0% | 4 |

The assignment of link selection parameter value to link corresponds to that specified in Table 1, although Table 2 additionally specifies a frequency H with which the different SLS values actually occur, a situation which is not taken into account by Q.7xx.

As can easily be seen, link 1 would in this case carry no traffic whatsoever, since the SLS values 0 . . . 3 do not occur at all in the MTP traffic stream. This situation arises for example with cascaded network elements which perform a load distribution on the basis of the SLS parameter, as a result of which at least one bit of the SLS parameter is “consumed” per cascade, i.e. at least one bit of the SLS parameter no longer varies in the message stream to the next network element considered here for example. In the example in Table 2 these can be the bits with the significance 2² and/or 2³, which always have the value “1”.

Link 2, on the other hand, would be assigned 50% of the total load, link 3 35% and link 4 15%. It is self-evident that an unbalanced load of this kind is undesirable.

This type of unbalanced load is prevented by means of the present invention in that the transported traffic volume per link selection parameter value is monitored, i.e. the frequency H specified in Table 2 is determined. Next, the link selection parameter values are reassigned to the connections (in this case: the links) in such a way that all the links carry the same load. In the present case this means that the SLS values are assigned to the links in such a way that each link carries 25% of the load.

In this scheme the reassignment can take place continuously, though this does not make sense on account of the necessary security measures against messages overtaking one another (see below). The reassignment preferably takes place at fixed time intervals, the following, for example, needing to be taken into account in order to select a suitable time interval: time taken for a full execution of the security measure; processor capacity available for the evaluations; capability of the links to be operated for short periods at high load. Alternatively or in addition, the reassignment can be made in response to specific events. Possible events are, for example: activation/deactivation of links, detection of particularly high load on a link.

The reassignment therefore serves the aim of assigning the frequencies of the SLS values listed in Table 2 to the links in such a way that approximately the same traffic volume, i.e. 25%, is assigned to each link. The SLS values 0 . . . 3 and 15 do not occur, so only the SLS values 4 . . . 14 need to be taken into account for the reassignment (extract from Table 2):

TABLE 3

| SLS value | H |
|---|---|
| 4 | 20% |
| 5 | 10% |
| 6 | 10% |
| 7 | 10% |
| 8 | 10% |
| 9 | 10% |
| 10 | 10% |
| 11 | 5% |
| 12 | 5% |
| 13 | 5% |
| 14 | 5% |

A possible new assignment of the SLS values to the links could then look as follows:

TABLE 4

| SLS value | H | Link |
|---|---|---|
| 4 | 20% | 1 |
| 11 | 5% | 1 |
| 5 | 10% | 2 |
| 6 | 10% | 2 |
| 12 | 5% | 2 |
| 7 | 10% | 3 |
| 8 | 10% | 3 |
| 13 | 5% | 3 |
| 9 | 10% | 4 |
| 10 | 10% | 4 |
| 14 | 5% | 4 |

Various possibilities of how the reassignment according to the invention can be implemented are immediately obvious to the person skilled in the art.

The SLS values that do not occur in the MTP message stream can be arbitrarily distributed over the links 1 . . . 4. Not to assign said SLS values, although possible in principle, carries the risk that problems will occur due to rearrangements in a preceding network element and subsequent occurrence of traffic with hitherto unassigned SLS values.

Finally, the following assignments of link selection parameter value to link result from Table 4 and taking into account the assignment of SLS values with a frequency of 0%:

TABLE 5

| SLS value | H | Link |
|---|---|---|
| 0 | 0% | 1 |
| 1 | 0% | 2 |
| 2 | 0% | 3 |
| 3 | 0% | 4 |
| 4 | 20% | 1 |
| 5 | 10% | 2 |
| 6 | 10% | 2 |
| 7 | 10% | 3 |
| 8 | 10% | 3 |
| 9 | 10% | 4 |
| 10 | 10% | 4 |
| 11 | 5% | 1 |
| 12 | 5% | 2 |
| 13 | 5% | 3 |
| 14 | 5% | 4 |
| 15 | 0% | 1 |

In the example in Tables 4 and 5, the result, based on the exemplary chosen frequencies of the occurrence of the individual SLS values, is a situation whereby the distribution is optimal in the sense that each link 1 . . . 4 is assigned precisely 25% of the load.

In other cases only an optimized load distribution is possible, i.e. as equal a ratio as possible of transported traffic volume to connection capacity for all links.

Considered for this purpose is the case from Tables 2-5, in which link 4 is not available for example due to a malfunction.

Each of the three remaining links would have to be assigned a load of 33.3%, which is not possible in the context of the exemplary frequencies of the occurrence of the individual SLS values. A possible new assignment of the SLS values to the links could look as follows:

TABLE 6

| SLS value | H | Link |
|---|---|---|
| 4 | 20% | 1 |
| 6 | 10% | 1 |
| 11 | 5% | 1 |
| 5 | 10% | 2 |
| 7 | 10% | 2 |
| 8 | 10% | 2 |
| 12 | 5% | 2 |
| 9 | 10% | 3 |
| 10 | 10% | 3 |
| 13 | 5% | 3 |
| 14 | 5% | 3 |

In the example shown in Table 6 an optimized distribution results in which links 1 and 2 each transport 35% of the traffic, while link 3 transports 30% of the traffic.

As already mentioned, the traffic statistics for determining the frequency can be based on the number of messages or on the number of transported bytes. The latter option allows more precise statistics and is useful in environments with messages of widely varying length, although it is in fact more complicated since the length information has to be taken from each MTP message.

In order to apply the method according to the invention to M3UA or MTP3/M2PA or MTP3/M2UA links, i.e. SCTP associations which transport M3UA, MTP3/M2PA or MTP3/M2UA messages, an application server to which multiple SCTP associations lead is defined as the destination. Subject to these requirements, the invention can then be used to achieve as even a distribution of the traffic as possible to multiple SCTP associations even in the case of unequal distribution of the traffic to link selection parameter values.

As already mentioned, the method can also be used in connection with any methods for extending the value set of the SLS parameter.

For networks in which links of different capacity or transfer rates are used, it can usefully be provided to load the links in proportion to their capacity instead of allocating approximately the same traffic volume to all the links. The ratio of transported traffic volume to capacity, for example, can serve as a measure for this proportionality, it then being achieved by means of the present invention that this ratio is approximately the same for all links.

In continuation of the above example, in which the traffic is distributed over three links, let it now be assumed for example that a link 1* has twice as much capacity as links 2 and 3. The optimal traffic distribution would then route 50% of the traffic via link 1* and 25% each via links 2 and 3. Based on Table 6, the following distribution, for example, can then be performed:

TABLE 7

| SLS value | H | Link |
|---|---|---|
| 4 | 20% | 1* |
| 5 | 10% | 1* |
| 6 | 10% | 1* |
| 7 | 10% | 1* |
| 8 | 10% | 2 |
| 9 | 10% | 2 |
| 11 | 5% | 2 |
| 10 | 10% | 3 |
| 12 | 5% | 3 |
| 13 | 5% | 3 |
| 14 | 5% | 3 |

In order to prevent messages overtaking one another during the reassignment of the link selection parameter values to the links, the change back function according to ITU-T Q.704 Section 6 can be used for all message streams that are routed via a different link after the rearrangement, i.e. for all reassignments of link selection parameter value to link. Said change back function is usually used to signal the redistribution of message streams following activation of a link. For the purpose of the present invention use is made here of the fact that a network element can also apply this function even when no link has been activated. In this case the sequence-controlled change back procedure is preferably used wherein sender and recipient exchange messages relating to the switchover of the traffic stream associated with a specific SLS value. Alternatively, particularly for SCTP/IP-based links, the time-controlled change back procedure can also be used, wherein the sending network element reroutes the traffic stream over a different link after a defined period of time has elapsed, without a confirmation being given by the receiving network element.

1.-12. (canceled)

13. A method for distributing SS7 traffic to a destination in an SS7 network over a plurality of connections, wherein the distribution is handled on the basis of link selection parameters that are derived from message fields of the SS7 traffic, and wherein a link is uniquely assigned to each link selection parameter value, the method comprising:
monitoring a traffic volume per link selection parameter value during the operation of the SS7 network; and
reassigning the link selection parameter values to the links on a time- or event-driven basis such that the ratio of transported traffic volume to connection capacity is as far as possible the same for all links, wherein a transfer procedure similar or identical to the change back procedure being used for links with reassigned link selection parameter values in order to avoid messages overtaking one another.

14. The method as claimed in claim 13, wherein the link selection parameters include at least the Signaling Link Selection parameter.

15. The method as claimed in claim 13, wherein for SS7 networks in which the connection capacity of all links to the destination is equal, the reassignment accordingly being handled in such a way that the transported traffic volume is as far as possible the same for all links.

16. The method as claimed in claim 14, wherein for SS7 networks in which the connection capacity of all links to the destination is equal, the reassignment accordingly being handled in such a way that the transported traffic volume is as far as possible the same for all links.

17. The method as claimed in claim 13, wherein the traffic volume per link selection parameter value is determined as the number of messages transmitted per link selection parameter value or as the information volume, measured in bytes, transmitted per link selection parameter value.

18. The method as claimed in claim 14, wherein the traffic volume per link selection parameter value is determined as the number of messages transmitted per link selection parameter value or as the information volume, measured in bytes, transmitted per link selection parameter value.

19. The method as claimed in claim 15, wherein the traffic volume per link selection parameter value is determined as the number of messages transmitted per link selection parameter value or as the information volume, measured in bytes, transmitted per link selection parameter value.

20. The method as claimed in claim 13, wherein for SS7 networks in which the transmission is based on the MTP Level 1, 2 and 3 protocols, the links accordingly including Signaling Links.

21. The method as claimed in claim 14, wherein for SS7 networks in which the transmission is based on the MTP Level 1, 2 and 3 protocols, the links accordingly including Signaling Links.

22. The method as claimed in claim 15, wherein for SS7 networks in which the transmission is based on the MTP Level 1, 2 and 3 protocols, the links accordingly including Signaling Links.

23. The method as claimed in claim 17, wherein for SS7 networks in which the transmission is based on the MTP Level 1, 2 and 3 protocols, the links accordingly including Signaling Links.

24. The method as claimed in claim 13, wherein for SS7 networks in which the transmission is based on the IP and SCTP protocols, the links accordingly including SCTP Associations.

25. The method as claimed in claim 14, wherein for SS7 networks in which the transmission is based on the IP and SCTP protocols, the links accordingly including SCTP Associations.

26. A method for distributing SS7 traffic to a destination in an SS7 network over a plurality of connections, wherein the distribution is performed on the basis of link selection parameters that are derived from message fields of the SS7 traffic, and wherein a link is uniquely assigned to each link selection parameter value, the method comprising:
monitoring a traffic volume per link selection parameter value during the operation of the SS7 network, wherein
the link selection parameter values are reassigned to the links on a time- or event-driven basis subject to the proviso that the ratio of transported traffic volume to connection capacity is as far as possible the same for all links, and wherein a transfer procedure similar or identical to the change back procedure is used for links with reassigned link selection parameter values in order to prevent messages overtaking one another.

27. A network element of an SS7 network having a mechanism for distributing SS7 traffic to a destination over a plurality of links, wherein the distribution is handled on the basis of link selection parameters derived from message fields of the SS7 traffic, and wherein a link is uniquely assigned to each link selection parameter value, the network element comprising:
a mechanism for monitoring a traffic volume per link selection parameter value during the operation of the SS7 network;
a mechanism for time- or event-driven reassignment of the link selection parameter values to the links such that the ratio of transported traffic volume to connection capacity is as far as possible the same for all links; and
a mechanism for avoiding messages overtaking one another, wherein the mechanism for avoiding messages overtaking one another effects a transfer procedure similar or identical to the change back procedure for links with reassigned link selection parameter values.

28. The network element as claimed in claim 27, wherein the mechanism for distributing comprises a mechanism for evaluating the Signaling Link Selection parameter as link selection parameter.

29. The network element as claimed in claim 27, wherein the links to the destination have the same connection capacity, and wherein the reassignment mechanism is designed in such a way that after the reassignment the transported traffic volume is as far as possible the same for all links.

30. The network element as claimed in claim 27, further comprising means for determining the traffic volume per link selection parameter value as the number of messages transmitted per link selection parameter value or as the information volume, measured in bytes, transmitted per link selection parameter value.

31. The network element as claimed in claim 27, wherein for SS7 networks in which the transmission is based on the MTP Level 1, 2 and 3 protocols whose links include Signaling Links.

32. The network element as claimed in claim 27, wherein for SS7 networks in which the transmission is based on the IP and SCTP protocols whose links include SCTP Associations.
